(19) United States
(12) Patent Application Publication
(10) Pub. No.: US 2023/0166341 A1
(43) Pub. Date: Jun. 1, 2023

(54) ADJUSTMENT UNIT FOR A GUIDE BAR ON A MACHINING TOOL, AND MACHINING TOOL

(71) Applicant: Guehring KG, Albstadt (DE)

(72) Inventor: Klaus MATHEIS, Sauldorf/Rast (DE)

(73) Assignee: Guehring KG, Albstadt (DE)

(21) Appl. No.: 18/046,571

(22) Filed: Oct. 14, 2022

Related U.S. Application Data
(63) Continuation of application No. PCT/DE2021/100339, filed on Apr. 14, 2021.

(30) Foreign Application Priority Data
Apr. 15, 2020 (DE) 10 2020 110 304.2

(51) Int. Cl. B23B 51/00

(52) U.S. Cl. CPC B23B 51/0054; B23B 2260/004

(57) ABSTRACT

An adjustment unit (1) for a guide bar (4) on a machining tool (0), comprising an actuation part (5) and the guide bar (4), wherein the actuation part (5) is connected to the machining tool (0) and directly or indirectly interacts with the guide bar (4) in order to move the guide bar (4) continuously in a radial direction R-R of the machining tool (0) by actuation of the actuation part (5).

The invention relates to an adjustment unit for a guide bar on a machining tool and a machining tool.

Machining tools, in the case of which guide bars are used on a regular basis, are, for example, deep hole drills. During the drilling process, the guide bars perform the task of guiding the drill along its circumference through the bore hole or to support it against the bore hole wall, respectively.

The guide bars are thereby typically screwed to the drill head on an opposite side of the cutter support. Just like the cutter support, guide bars from the prior art have to be produced and used for a predetermined nominal diameter of the machining tool.

A disadvantage from this prior art is that guide bars are used only for machining tools with one nominal diameter. These guide bars have to always be provided and stored for this exact nominal diameter. The guide bars can also not be used for machining tools with nominal diameters, which vary in a nominal diameter range.

For changing to a machining tool with a different nominal diameter, it is known to insert washers for the gradual adaptation between machining tool and guide bar. However, it is a disadvantage thereby that a continuous and thus more exact adaptation is not possible in this way.

It is the object of the present invention to provide an adjustment unit for a guide bar on a machining tool, which overcomes the disadvantages from the prior art and which is suitable to optimally adapt the guide bar to the machining tool, as well as a machining tool.

The invention comprises an adjustment unit for a guide bar, which is to be arranged on a machining tool. The adjustment unit comprises an actuation part and a guide bar. The actuation part is thereby connected to the machining tool and directly or indirectly interacts with the guide bar in order to move the guide bar continuously along a radial direction R-R of the machining tool by actuation of the actuation part. Due to the continuous adjustment, the position of the guide bar can be optimally adapted to the machining tool. An adjustment unit comprising a guide bar can thus be used for several machining tools or machining tool diameters, respectively.

According to a preferred aspect, the actuation part is a screw. The screw can thereby be formed (e.g. by means of a corresponding shaping on the screw head or screw shaft for engagement with the guide bar) in order to effect a movement of the guide bar continuously (e.g. parallel to the wall of the resulting bore hole) along the radial direction R-R of the machining tool by rotating the screw.

According to a further preferred technical aspect, the adjustment unit comprises at least a first adjustment part. The first adjustment part is thereby formed in order to transfer a movement from the actuation part to the guide bar. The first adjustment part can thereby have the shape of a wedge, wherein the guide bar can thereby be moved continuously over the tilt of the wedge along the radial direction R-R of the machining tool.

According to a particularly preferred aspect, the first adjustment part has at least a first stop surface. The first stop surface is thereby located at an angle α opposite to the radial direction R-R. The guide bar thereby has a second stop surface, wherein the second stop surface is located at an angle α opposite to the radial direction R-R. The first stop surface is thereby arranged on the second stop surface. The angle α is thereby between 91° and 140°.

According to an advantageous aspect, the first adjustment part is formed in order to move the guide bar continuously along a radial direction R-R of the machining tool by means of a movement of the first adjustment part, which is directed essentially along an axial direction A-A of the machining tool.

The adjustment unit advantageously comprises at least a second adjustment part. The second adjustment part is thereby formed in order to transfer a movement from the actuation part to the first adjustment part. The second adjustment part can thereby have the shape of a wedge, wherein the first adjustment part can thereby be moved continuously over the tilt of the wedge.

According to a particularly advantageous aspect, the second adjustment part has at least a third stop surface. The third stop surface is thereby located at an angle β opposite to the axial direction A-A. The first adjustment part thereby has a fourth stop surface, wherein the fourth stop surface is located at an angle β opposite to the axial direction A-A. The third stop surface is thereby arranged on the fourth stop surface. The angle β is thereby between 91° and 140°.

According to a preferred aspect, the second adjustment part is formed in order to move the guide bar continuously along a radial direction R-R of the machining tool by means of a movement of the first adjustment part, which is directed essentially along a radial direction R-R of the machining tool.

It is also preferred when the adjustment unit comprises at least one fastening part. The fastening part is thereby formed in order to fasten the guide bar against the machining tool in at least the radial direction R-R of the machining tool.

Particularly advantageously, the at leas tone fastening part is a screw. The screw can thereby be screwed to the machining tool, and the head of the screw is formed in order to fasten the guide bar with one front face in at least the radial direction R-R of the machining tool.

According to a further aspect, the invention relates to a machining tool comprising at least one adjustment unit for a guide bar. The guide bar can thereby be moved continuously along the radial direction R-R of the machining tool via the adjustment unit.

The invention will be described in more detail below on the basis of the examples illustrated in the enclosed drawings. Identical reference numerals relate to identical features in all figures, in which:

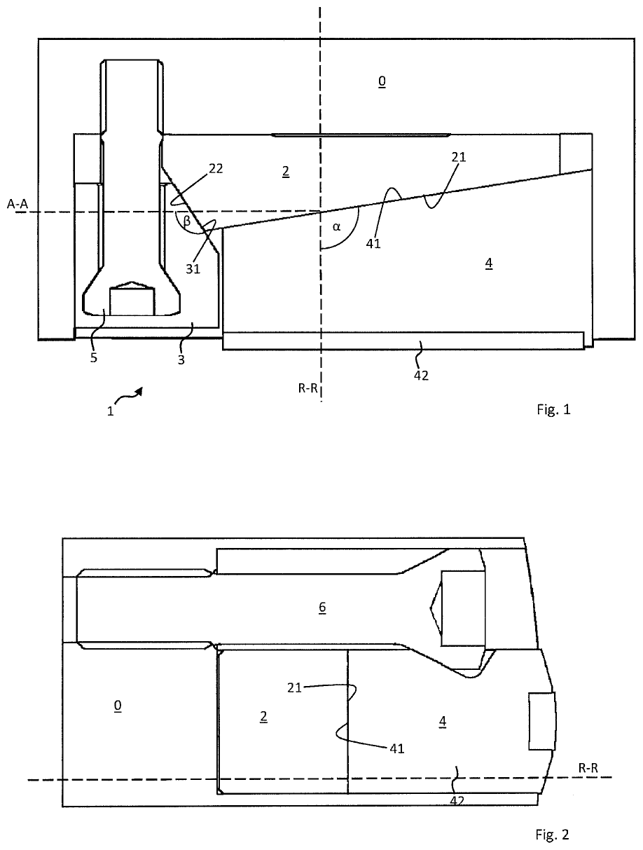

FIG. 1 shows a view of a longitudinal section of the adjustment unit comprising a guide bar when installed on a machining tool;

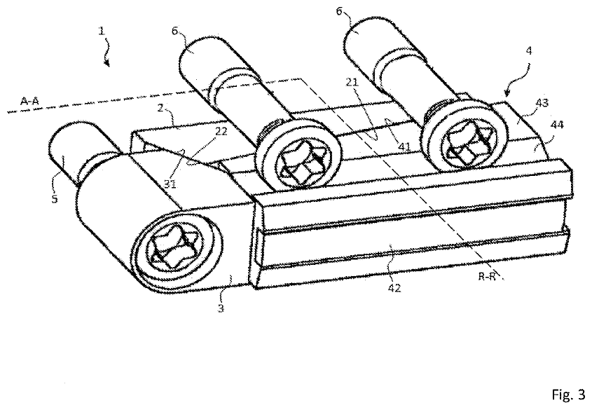

FIG. 2 shows a view of a cross section of the adjustment unit from FIG. 1; and

FIG. 3 shows a perspective view of an adjustment unit comprising a guide bar, which can be arranged on a machining tool.

A schematic illustration of the adjustment unit 1 according to the invention is shown in a longitudinal section in FIG. 1. The adjustment unit 1 is installed on a machining tool 0.

The adjustment unit 1 comprises an actuation part 5 and a guide bar 4. The actuation part 5 is connected to the machining tool 0 and directly or indirectly interacts with the guide bar 4 in order to move the guide bar 4 continuously in a radial direction R-R of the machining tool 0 by actuation of the actuation part 5.

To adjust the guide bar 4 via the actuation part 5, the adjustment unit 1 comprises a first adjustment part 2, which is moved to the right by the actuation part 5 or actuation part 5 and second adjustment part 3, respectively, during a movement, and which thus pushes the guide bar 4 to the bottom.

For this purpose, the first adjustment part 2 has a first stop surface 21 on the underside. The first stop surface 21 is arranged at an angle α opposite to the radial direction R-R. The guide bar 4 has a second stop surface 41, which is arranged on the top side. The second stop surface 41 is arranged at an angle α opposite to the radial direction R-R and abuts flat on the stop surface 21. The first stop surface 21 is arranged in a displaceable manner against the second stop surface 41.

The first adjustment part 2 is moved to the right in this way along a movement in axial direction A-A of the machining tool 0, and continuously pushes the guide bar 4 to the bottom along a radial direction R-R of the machining tool 0, so that the distance of the guide bar to the tool axis is adjusted.

In the shown example, the actuation part 5 is arranged in the form of a screw in the second adjustment part 3 and has a third stop surface 31 on the right side. The third stop surface 31 is arranged at an angle β against the axial direction A-A. The first adjustment part 2 has a complementarily formed fourth stop surface 22. The fourth stop surface 22 is arranged at an angle β opposite to the axial direction A-A. The third stop surface 31 abuts on the fourth stop surface 22, and both can be displaced to one another in the stop plane.

The second adjustment part 3 is formed with the angle of the third stop surface 31 in such a way that the first adjustment part 2 is pushed continuously in the direction of the guide bar 4 during a movement in the radial direction R-R of the machining tool 0, and the guide bar 4 displaces continuously in the radial direction R-R of the machining tool 0.

FIG. 2 likewise shows the machining tool 0 from FIG. 1 comprising an adjustment unit 1 for a guide bar 4.

A fastening part 6, by means of which the adjustment unit is fastened to the machining tool, can be seen in this sectional illustration. The illustrated fastening part 9 is a screw. The fastening part 6 is formed in order to clamp the guide bar 4 against the machining tool 0 in the radial direction R-R of the machining tool 0.

A perspective view of an adjustment unit 1 comprising a guide bar 4 is shown in FIG. 3, wherein the guide bar 4 comprises a guide bar holder 43 and a guide bar insert 42. The guide bar holder 43 comprises a groove 44, in which two fastening parts 6 abut on one another. The fastening parts 6 run through the first adjustment part 2 in order to clamp the adjustment unit 1 against the machining tool (not illustrated) by means of screw-connecting.

In the installed state, the guide bar 4 is adjusted in the direction R-R, in that the second adjustment part 3 is moved in the direction of the machining tool by means of the actuation screw 5. The third stop surface 31 thereby pushes against the fourth stop surface 22 and pushes the first adjustment part 2 in the direction A-A, whereby the first stop surface 21 pushes against the second stop surface 41, and thus pushes the first adjustment part 2 against the guide bar 4 in order to displace the latter in the direction R-R. As a result, the guide bar 4 is pushed in the opposite direction due to a movement of the second adjustment part 3 in a first direction.

1. An adjustment unit for a guide bar on a machining tool comprising an actuation part and a guide bar, wherein the actuation part is connected to the machining tool and directly or indirectly interacts with the guide bar in order to move the guide bar continuously along a radial direction of the machining tool by actuation of the actuation part.

2. The adjustment unit according to claim 1, wherein the actuation part is a screw.

3. The adjustment unit according to claim 1, wherein the adjustment unit comprises at least a first adjustment part, wherein the first adjustment part is formed in order to transfer a movement from the actuation part to the guide bar.

4. The adjustment unit according to claim 3, wherein the first adjustment part has at least a first stop surface, wherein the first stop surface is located at an angle α opposite to the radial direction, and wherein the guide bar has a second stop surface, wherein the second stop surface is located at an angle α opposite to the radial direction, and wherein the first stop surface is arranged on the second stop surface.

5. The adjustment unit according to claim 3, wherein the first adjustment part is formed in order to move the guide bar continuously along a radial direction of the machining tool by means of a movement of the first adjustment part, which is directed essentially along an axial direction of the machining too.

6. The adjustment unit according to claim 3, wherein the adjustment unit comprises at least a second adjustment part, wherein the second adjustment part is formed in order to transfer a movement from the actuation part to the first adjustment part.

7. The adjustment unit according to claim 6, wherein the second adjustment part has at least a third stop surface, wherein the third stop surface is located at an angle β opposite to an axial direction of the machining tool, and wherein the first adjustment part has a fourth stop surface, wherein the fourth stop surface is located at an angle β opposite to the axial direction, and wherein the third stop surface is arranged on the fourth stop surface.

8. The adjustment unit according to claim 6, wherein the second adjustment part is formed in order to move the guide bar continuously along a radial direction of the machining tool by a movement of the first adjustment par, which is directed essentially along the radial direction of the machining tool.

9. The adjustment unit according to claim 1, comprising at least one fastening, wherein the fastening part is formed in order to fasten the guide bar against the machining tool in at least a radial direction of the machining tool.

10. The adjustment unit according to claim 9, wherein the at least one fastening part is a screw.

11. A machining tool comprising at least one adjustment unit for a guide bar according to claim 1.
